(19) United States
(12) Patent Application Publication
(10) Pub. No.: US 2002/0046565 A1
(43) Pub. Date: Apr. 25, 2002

(54) Device and method for generating torque using thermal energy

(76) Inventor: Daun Singh, Fairfax, VA (US)

Correspondence Address: BIRCH STEWART KOLASCH & BIRCH, PO BOX 747, FALLS CHURCH, VA, 22040-0747, US

(21) Appl. No.: 09/832,216

(22) Filed: Apr. 11, 2001

Related U.S. Application Data
(60) Provisional application No. 60/196,090, filed on Apr. 11, 2000.

(51) Int. Cl. H02N 10/00; F02G 1/04

(52) U.S. Cl. 60/527; 310/306

(57) ABSTRACT

A device and method for generating a torque, by using waste or otherwise underutilized or unutilized thermal energy. A rotor for an electrical engine is driven to rotate using such thermal energy. The rotor includes a hollow central tube with endplates rotatably mounted thereon. A plurality of magnets and elongated members extend between the endplates. A wire loop made of shape memory effect material is wound about the central tube and each of the elongated members. The rotor operates in cooperation with a stator in which a coil is provided.

### FIELD OF THE INVENTION

The present invention relates to a device that generates a torque using thermal energy. In a particular application, the present invention can be used to drive a rotor in an electric generator to generate electrical energy. The present invention particularly relates to generating a torque using waste thermal energy or sources of thermal energy not normally used for the generation of electrical power.

### BACKGROUND OF THE INVENTION

It is a well-recognized problem that most forms of electrical generation are extremely inefficient. For example, in a typical diesel-fired power plant, about 72% of the energy input is lost as waste heat. Similarly, in a typical coal-fired power plant, about 64% of the energy input is lost as waste heat.

In addition, thermal energy sources exist that are either underutilized or not utilized at all for energy production. One example is lava tubes in volcanic areas of the Hawaiian Islands. Other examples include geysers and other areas of geothermal energy emanation.

### SUMMARY OF THE INVENTION

In view of the foregoing, it is desirable to utilize the abovementioned sources of waste or otherwise unutilized thermal energy for a beneficial end.

Therefore, the present invention is directed, most generally, to a device and method for generating a torque using thermal energy, especially waste or otherwise unutilized sources of thermal energy. More particularly, the present invention is directed to an electrical generator rotor and method for driving an electrical generator rotor using thermal energy as discussed above.

The device and method for generating a torque using thermal energy may be used, generally, to rotatably drive a rotatably mounted assembly. For example, the device includes a rotatably mounted assembly mounted about a hollow central tube. The assembly according to the present invention includes, for example, a pair of spaced apart endplates having a plurality of satellite tubes extending therebetween. The central tube, for example, passes through both endplates so that the endplates (and the satellite tubes mounted on the endplates) rotate about the central tube.

The central tube serves as a conduit for a heated working fluid, especially, but not limited to, water. The working fluid may be heated in any known manner, especially using waste or otherwise un-utilized sources of thermal energy.

The plurality of satellite tubes and the central tube are preferably, but not necessarily, substantially parallel. A plurality of wires made from a shape-memory effect material (such as nitinol) are formed into closed loops about the central tube and the respective satellite tubes. Several such wires are looped about the central tube and a given satellite tube.

The wire loops can be trained (in a manner known in the field of shape-memory effect materials) to move (using the shape-memory effect) back to a remembered configuration to create a tangential force component that tends to cause the satellite tube to rotate about the central tube.

The rotation of the satellite tubes can be used, for example, to generate electricity. For example, a plurality of oppositely-poled magnet pairs may be mounted on diametrically opposed sides of the endplate/satellite tube assembly so as to act as a rotor for a generator. A coil, as is known in the art, may be statically provided in a stator, which may be in the form of a housing surrounding the rotating assembly. Thus, the relative motion of the rotor relative to the magnets is provided by moving the magnets, thereby generating electricity in a known manner.

A method for generating torque according to the present invention includes: rotatably mounting a pair of endplates about a central tube, providing a plurality of satellite tubes extending between the endplates such that the endplates and the satellite tubes are rotatable about the central tube, providing at least one wire made from a shape-memory effect material looped about the central tube and each satellite tube, feeding thermal energy through the central tube so as to activate the shape memory effect in each wire loop so as to cause an asymmetric circumferential deformation in the wire loop, thereby creating a torque on the respective tubes, which in turn causes the endplate/satellite tube assembly to rotate about the central tube.

As discussed above, a method for generating electricity in accordance with the method according to the present invention includes providing a plurality of oppositely poled magnets on diametrically opposite sides of the rotatable endplate/satellite tube assembly, and a housing (i.e., a stator) in which a static coil is mounted. When the assembly having the magnets mounted thereon is driven to rotate, the magnets are moved relative to the coil, thereby generating an electric current in a known manner.

### BRIEF DESCRIPTION OF THE DRAWINGS

The present invention will be described hereinbelow with reference to the attached drawings, in which:

FIG. 1 is a first perspective view of a rotating assembly according to the present invention;

FIG. 2 is a second perspective view of a rotating assembly according to the present invention;

FIG. 3 illustrates a housing in which a coil is provided to act as a stator, and a rotating assembly provided with magnets to act as a rotor in an electric generator;

FIG. 4 illustrates a shape memory effect of the wire loops used in the present invention; and

FIG. 5 illustrates a system for using waste heat gathered from flue gas exhaust in a power plant to drive an array of generators constructed and operated according to the present invention.

### DETAILED DESCRIPTION OF PREFERRED EMBODIMENT

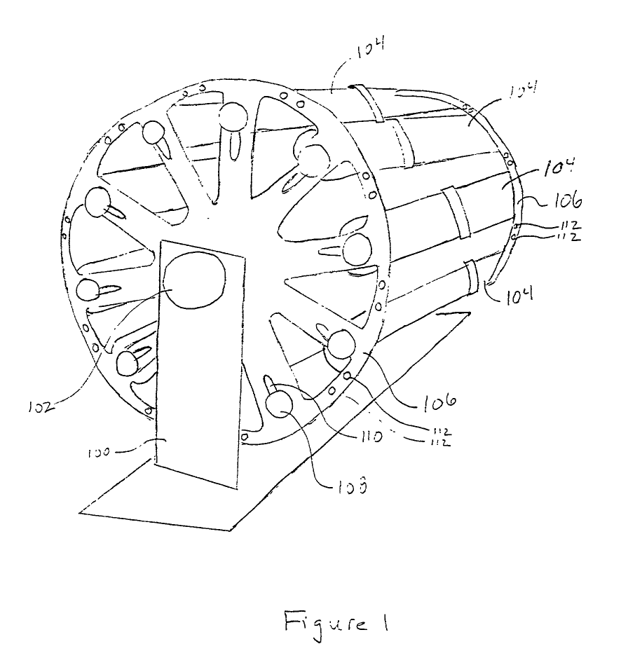

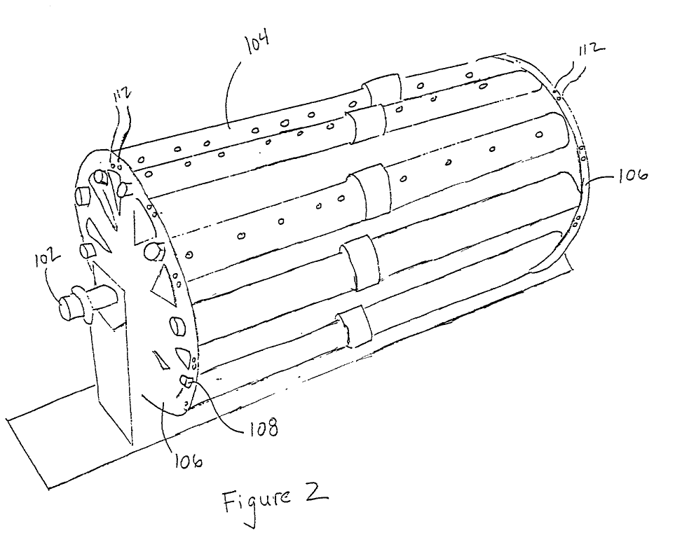

FIGS. 1 and 2 are perspective views of a rotatable assembly according to the present invention.

In general, the assembly includes a support 100 supporting opposite ends of a hollow central tube 102. A plurality of satellite tubes 104 are mounted at respective ends thereof on a pair of end plates 106. For example, five pairs of diametrically disposed satellite tubes 104 may be provided, as illustrated in FIGS. 1 and 2, although a different number of satellite tubes may be provided in a variety of relative arrangements according to the present invention. Central tube 102 passes through both end plates 106 so that the satellite tubes 106 mounted on end plates 104 are rotatable about central tube 102. If desirable, a conventional friction-reducing mechanism may be provided to facilitate the rotation of the end plates 104 about central tube 102, such as ball bearings or the like. However, satellite tubes 106 are preferably static relative to end plates 106 (i.e., satellite tubes 106 preferably do not rotate about their respective axes).

Each satellite tube 106 may be mounted relative to end plates 104 using screws 108, passed through slots 110 formed in each end plate 106. Respective slots 110 in the end plates 104 are preferably aligned with one another so as to extend radially outward from the central tube 102, such that a respective satellite tube 106 can be fixed at different radial distances from the central tube 102. Screws 108 may be of any known form, including a finger-tightened screw as shown in FIGS. 1 and 2.

The central tube 102 is preferably made from metal or other material that has high thermal conductivity. Satellite tubes 104 and end plates 106 are preferably made from lightweight materials including, without limitation, various forms of plastics, polymers, and the like. Plastic materials and the like are desirable with respect to their light weight and generally low cost. However, suitable lightweight metal materials may be used according to the present invention.

The central tube 102 carries a heated working fluid therethrough. A desirable working fluid according to the present invention is water heated to, for example, 75-80° C. The temperature of the working fluid must be in accordance with the critical temperature of the shape memory effect material used for the wires looped about the central tube 102 and the respective satellite tubes 106, as discussed below.

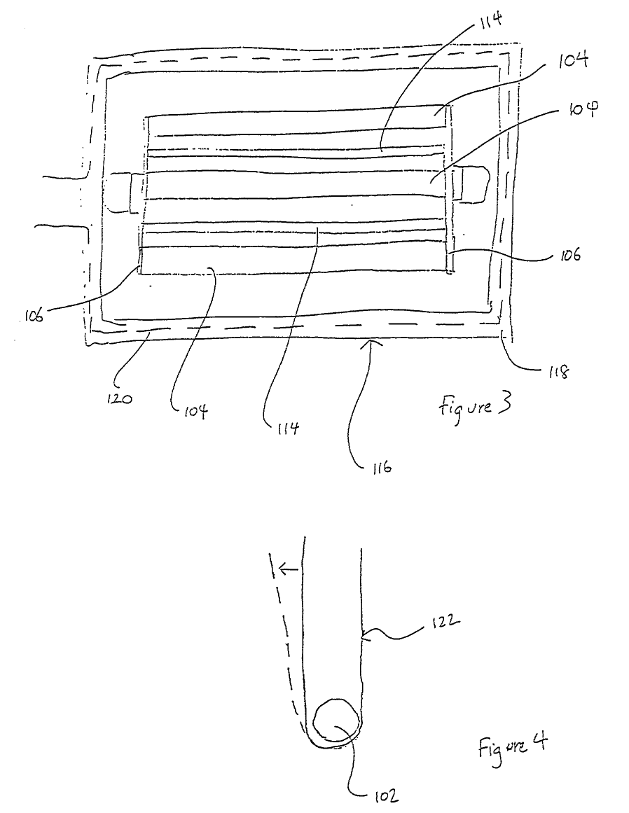

As mentioned above, the assembly may carry a plurality of oppositely poled magnet pairs 114 mounted thereon (for example, fastened onto end plates 106 by means of fastener holes 112). For example, magnets 114 may be attached to endplates 106 at locations between respective satellite tubes 104. See FIG. 3. When the assembly of satellite tubes 104 mounted on end plates 106 is rotated with magnets 114 mounted thereon, the assembly can be used as a rotor of an electrical generator.

A stator 116 for such a generator is generally illustrated in FIG. 3. Stator 116 may, for example, include a housing 118 surrounding the assembly shown in FIGS. 1 and 2. In one possible arrangement according to the present invention, a housing 118 may include a coil 120 embedded therein, the coil 120 preferably lying in a plane generally parallel to central tube 102. In general, an arrangement of magnets rotating relative to a fixed coil to generate electricity is known in the art. In operation, a generator including a rotor carrying magnets and a stator providing a coil therearound functions in a known manner, so a specific description thereof is omitted here.

As mentioned above, at least one wire, made from a shape-memory effect material such as nitinol, is looped about the central tube 102 and each respective satellite tube 104. Usually, a plurality of such wires are looped about the central tube 102 and each satellite tube 104. Each loop is, for example, a length of wire having its ends joined to each other in any conventional manner. One method of joining the ends is to use a laser to make a spot weld. Most preferably, the ends of the wire are joined so as to not cause any discontinuities in the shape memory effect along the length of the loop.

Preferably, the central tube 102 and the satellite tubes 104 do not rotate about their own axes while the endplates 106 rotate about the central tube 102. Moreover, the wire loops surround the central tube 102 and respective satellite tubes relatively snugly. Thus, as the endplates 106 rotate about the central tube 102, friction between the wire loops and the central tube 102 and satellite tubes 104 causes each wire loop to translate between central tube 102 and satellite tubes 104 (in a manner similar to a belt translating between two driven rollers).

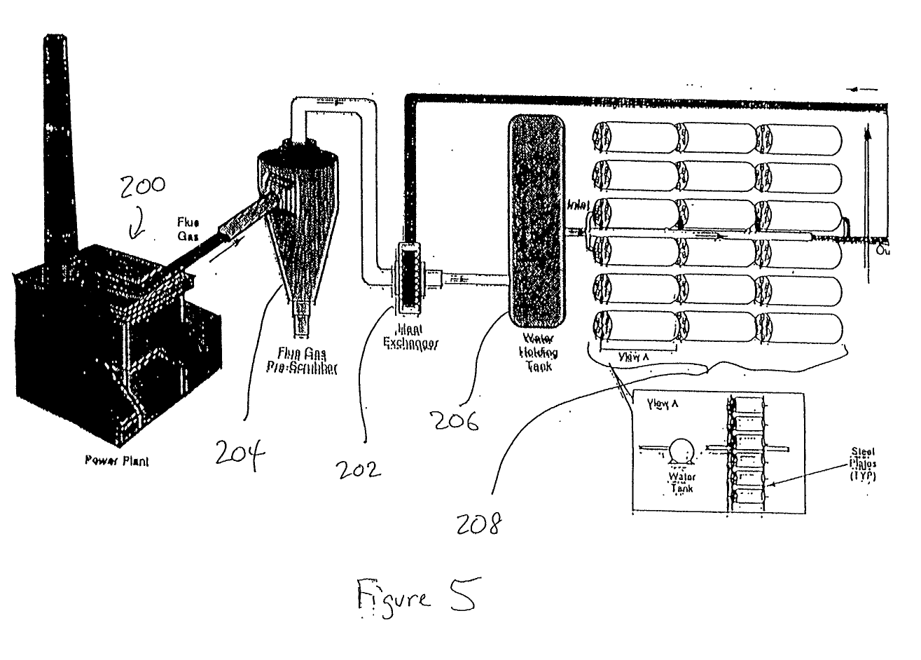

As illustrated in FIG. 4, each wire loop 122 generally has a u-shape as it turns about the central tube 102, as seen in cross-section. Once the shape memory in the wire loop 122 is activated by thermal contact with the central tube 102, one side of the wire loop spreads laterally (as seen in phantom, with great exaggeration, in FIG. 4). The wire loop 122 is “trained” to behave in this way in a manner known in the field of shape memory effect materials.

The asymmetric deformation illustrated in FIG. 4 imparts a tangential component of force on a respective satellite tube 104 in the direction of the deformation (the central tube 102 being essentially fixed). In the case illustrated in FIG. 4, for example, a tangential force to the left (with respect to the drawing) would be applied to the respective satellite tube 104. The sum of such tangential forces over all of the wire loops used is sufficient to cause the endplates 106 and satellite tubes 104 (and the magnets 114, if provided) to rotate about the central tube 102. The radial distance between a satellite tube 104 and central tube 102 may be altered so as to control the torque applied to the assembly, and, in turn, the speed at which the assembly rotates about the central tube 102.

FIG. 5 illustrates a system for generating electricity using waste heat captured from flue gas exhaust in a conventional power plant.

In general, a power plant 200 emits heated flue gas exhaust (for example, as a byproduct of burning coal, oil, natural gas, etc.). The flue gas is directed to conventional heat exchanger 202 for heating a working fluid, such as water. The heated working fluid may be temporarily stored in an insulated storage tank 206. The heated working fluid is distributed to one or more generators 208 constructed according to the present invention. The one or more generators 208 are constructed in accordance with the foregoing description, and generates electricity in a known manner. The electrical energy obtained from the one or more generators 208 is used as desired. The cooled working fluid is cycled back to heat exchanger 202 to repeat the cycle. In this manner, thermal energy from the conventional power plant, which would normally have been lost as waste, is used to generate the overall output of the power plant.

Although FIG. 5 illustrates an example in which waste heat is taken from a conventionally-fired power plant, the present invention is equally applicable to other sources of thermal energy, including, without limitation, a solar-heated working fluid, a lava tube (using appropriate conventional heat exchanging technology), and geothermal energy (such as from geysers).

Thus, while there have been shown and described and pointed out fundamental novel features on the invention as applied to preferred embodiments thereof, it will be understood that various omissions and substitutions and changes in the form and details of the devices illustrated, and in their operation, and in the method illustrated and described, may be made by those skilled in the art without departing from the spirit of the invention.

1. A device for generating a torque, comprising:
a hollow central tube;
a pair of endplates mounted on said central tube, such that said pair of endplates are rotatable about said central tube;
a plurality of elongate members extending between said pair of endplates and radially spaced apart from said central tube, such that said plurality of elongate members are rotatable about said central tube along with said pair of endplates; and
at least one wire loop made from a shape memory effect material wound about said central tube and each of said plurality of elongate members, said wire having been trained in accordance with shape memory effect principles to asymmetrically deform when locally heated, each of said wire loops being oriented so said asymmetric deformation occurs in the same direction.

2. An electric generator comprising:
a rotor comprising:
a hollow central tube;
a pair of endplates mounted on said central tube such that said pair of endplates are rotatable about said central tube;
a plurality of elongate members extending between said pair of endplates and radially spaced apart from said central tube, such that said plurality of elongate members are rotatable about said central tube along with said pair of endplates;
a plurality of oppositely poled magnet pairs, one magnet of each said pair extending between said endplates diametrically opposite the other said magnet of the pair; and
at least one wire loop made from a shape memory effect material wound about said central tube and each of said plurality of elongate members, said wire having been trained in accordance with shape memory effect principles to asymmetrically deform when locally heated, each of said wire loops being oriented so said asymmetric deformation occurs in the same direction; and
a stator including:
a housing at least partially surrounding said rotor, said housing including a coil surrounding said rotor, said coil being generally parallel to said central tube.

3. A system for generating electrical power comprising:
a first sub-system for heating a working fluid using heat from a thermal source;
a second sub-system for feeding said heated working fluid to at least one electrical generator, said at least one electrical generator including:
a rotor including:
a hollow central tube for receiving said heated working fluid;
a pair of endplates mounted on said central tube such that said pair of endplates are rotatable about said central tube;
a plurality of elongate members extending between said pair of endplates and radially spaced apart from said central tube, such that said plurality of elongate members are rotatable about said central tube along with said pair of endplates;
a plurality of oppositely poled magnet pairs, one magnet of each said pair extending between said endplates diametrically opposite the other said magnet of the pair; and
at least one wire loop made from a shape memory effect material wound about said central tube and each of said plurality of elongate members, said wire having been trained in accordance with shape memory effect principles to asymmetrically deform when locally heated, each of said wire loops being oriented so said asymmetric deformation occurs in the same direction; and
a stator including:
a housing at least partially surrounding said rotor, said housing including a coil surrounding said rotor, said coil being substantially parallel to said central tube; and
a third sub-system for returning the working fluid from said at least one electrical generator to said first system.

4. The system according to claim 3, wherein said second sub-system includes a plurality of said electrical generators.

5. An engine comprising:
a central tube;
a pair of endplates mounted on said central tube;
at least one elongated member extending between said pair of endplates;
at least one wire loop around the central tube and said elongated member, said wire loop including a shape memory effect material.

6. The engine of claim 5, wherein
the central tube is hollow.

7. The engine of claim 5, wherein
the endplates are rotatable about the central tube.

8. The engine of claim 5, wherein
the wire has been trained in accordance with shape memory effect principles to asymmetrically deform when locally heated, each of said wire loops being oriented so said asymmetric deformation occurs in the same direction.

9. The engine of claim 5, further comprising:
a plurality of elongate members extending between the pair of endplates and radially spaced apart from the central tube such that the elongate members and said pair of end plates are rotatable about the central tube.

10. The engine of claim 5, further comprising:
a plurality of said wire loops about the central tube and said elongate member.

11. A method for generating torque comprising:
rotatably mounting a pair of endplates about a central tube;
providing a plurality of satellite tubes extending between the endplates such that the endplates and the satellite tubes are rotatable about the central tube;
looping wire including a shape memory effect material about the central tube and each satellite tube of the plurality of satellite tubes; and
creating asymmetric circumferential deformation in the wire loop by feeding thermal energy through the central tube so as to activate the shape memory effect in each wire loop,
wherein a torque on the respective tubes is generated and causes the pair of endplates and plurality of satellite tubes to rotate about the central tube.

12. A method for generating electricity comprising:
rotatably mounting a pair of endplates about a central tube;
providing a plurality of satellite tubes extending between the endplates such that the endplates and the satellite tubes are rotatable about the central tube;
looping wire including a shape memory effect material about the central tube and each satellite tube of the plurality of satellite tubes;
mounting a plurality of oppositely poled magnet pairs on the endplates, such that one magnet of each said pair is between the endplates and diametrically opposite the other magnet of the pair;
mounting a housing in which a static coil is mounted; and
creating asymmetric circumferential deformation in the wire loop by feeding thermal energy through the central tube so as to activate the shape memory effect in each wire loop,
wherein a torque on the tubes is generated and causes the satellite tubes and magnets to rotate about the central tube and generate electricity.

13. A device for generating torque comprising:
an engine having shape memory alloys.
